(19) United States
(12) Patent Application Publication
(10) Pub. No.: US 2024/0087572 A1
(43) Pub. Date: Mar. 14, 2024

(54) SYSTEMS AND METHODS FOR SEMANTIC SEGMENTATION FOR SPEECH

(71) Applicant: MICROSOFT TECHNOLOGY LICENSING, LLC, Redmond, WA (US)

(72) Inventors: Sayan Dev PATHAK, Kirkland, WA (US); Amit Kumar AGARWAL, Redmond, WA (US); Amy Parag SHAH, Bothell, WA (US); Sourish CHATTERJEE, Bothell, WA (US); Zoltan ROMOCSA, Kenmore, WA (US); Christopher Hakan BASOGLU, Everett, WA (US); Piyush BEHRE, Santa Clara, CA (US); Shuangyu CHANG, Davis, CA (US); Emilian Yordanov STOIMENOV, Bellevue, WA (US)

(21) Appl. No.: 17/986,516

(22) Filed: Nov. 14, 2022

Related U.S. Application Data
(60) Provisional application No. 63/406,572, filed on Sep. 14, 2022.

(51) Int. Cl. G10L 15/26; G10L 15/08

(52) U.S. Cl. CPC G10L 15/26; G10L 15/08; G10L 2015/088

(57) ABSTRACT

Systems are configured to obtain streaming audio data comprising language utterances, continuously decode the streaming audio data in order to generate decoded streaming audio data and determine whether a linguistic boundary exists within an initial segment of decoded streaming audio data. When a linguistic boundary is determined to exist, the systems apply a punctuation at the linguistic boundary and output a first portion of the initial segment of the streaming audio data ending at the linguistic boundary while refraining from outputting a second portion of the initial segment which is located temporally subsequent to the first portion of the initial segment. Systems are also configured to delay the output until predetermined punctuation validation processes have been performed.

### CROSS-REFERENCE TO RELATED APPLICATIONS

This application claims the benefit of and priority to U.S. Provisional Patent Application Ser. No. 63/406,572 filed on Sep. 14, 2022, and entitled “SYSTEMS AND METHODS FOR SEMANTIC SEGMENTATION FOR SPEECH,” which application is expressly incorporated herein by reference in its entirety.

### BACKGROUND

Automatic speech recognition systems and other speech processing systems are used to process and decode audio data to detect speech utterances (e.g., words, phrases, and/or sentences). The processed audio data is then used in various downstream tasks such as search-based queries, speech to text transcription, language translation, closed captioning, etc. Oftentimes, the processed audio data needs to be segmented into a plurality of audio segments before being transmitted to downstream applications, or to other processes in streaming mode.

Conventional systems are configured to perform audio segmentation for continuous speech today based on timeout driven logic. In such speech recognition systems, audio is segmented after a certain amount of silence has elapsed at the end of a detected word (i.e., when the audio has “timed-out”). This time-out-based segmentation does not consider the fact that somebody may naturally pause in between a sentence while thinking what they would like to say next. Consequently, the words are often chopped off in the middle of a sentence before somebody has completed elucidating a sentence. This degrades the quality of the output for data consumed by downstream post-processing components, such as by a punctuator or machine translation components. Previous systems and methods were developed which included neural network-based models that combined current acoustic information and the corresponding linguistic signals for improving segmentation. However, even such approaches, while superior to time-out-based logic, were found to over-segment the audio leading to some of the same issues as the time-out-based logic segmentation.

For example, FIG. 1A-1B depict a conventional automatic speech recognition system comprising a decoder 104, a punctuator 108, and a user display 112. Audio 102 comprising spoken language utterances (e.g., spoken language utterances such as “i will walk the dog tonight at ten pm i will . . . feed him after i walk him”, audio 114) is used as input to the decoder 104 which decodes the audio 102 and outputs a decoded segment 106 (e.g., “i will walk the dog tonight at ten pm i will”, decoded segment 118). This decoded segment 106 is input to the punctuator 108 which punctuates the decoded segment 106 in order to output a punctuated output 110 (e.g., “I will walk the dog tonight at ten pm. I will.”, punctuated output 122). This punctuated output 110 is then transmitted to the user display 112 to be displayed to a user.

However, as shown in FIG. 1B, the system has not properly punctuated the punctuated output, because of the inclusion of the partial sentence “I will.” which is an incomplete sentence. This degrades the viewing quality of the transcription on the user display because the user is presented with this incorrect punctuated output. The system may be able to go back and re-output a corrected version of the output, but conventional systems replace the already displayed incorrect output with the newly corrected output, which can be confusing to a user who is viewing the user display being dynamically changed with different outputs of the same portion of audio data.

In view of the foregoing, there is an ongoing need for improved systems and methods for segmenting audio in order to generate more accurate transcriptions that correspond to complete speech utterances included in the audio and high quality displaying of those transcriptions.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems, methods, and devices for generating transcriptions for spoken language utterances recognized in input audio data.

For example, systems are provided for obtaining streaming audio data comprising language utterances from a speaker, continuously decoding the streaming audio data in order to generate decoded streaming audio data, and determining whether a linguistic boundary exists within an initial segment of decoded streaming audio data. When a linguistic boundary is determined to exist, the systems apply a punctuation at the linguistic boundary and output a first portion of the initial segment of the streaming audio data ending at the linguistic boundary while refraining from outputting a second portion of the initial segment which is located temporally subsequent to the first portion of the initial segment.

Systems are also provided for continuously decoding the streaming audio data in order to generate decoded streaming audio data and determining whether a linguistic boundary exists within an initial segment of decoded streaming audio data. When a linguistic boundary is determined to exist, the systems apply an initial punctuation at the linguistic boundary. However, subsequent to the initial punctuation, the systems wait a pre-determined number of newly decoded words included in the streaming audio data in order to validate that the initial punctuation is correct. Upon determining that the initial punctuation is correct, the system(s) output a first portion of the initial segment of the streaming audio data ending at the initial punctuation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIGS. 1A-1B illustrates various example embodiments of existing speech recognition and transcription generation systems.

FIG. 2 illustrates a computing environment in which a computing system incorporates and/or is utilized to perform disclosed aspects of the disclosed embodiments.

FIGS. 3A-3C illustrate various examples and/or stages of a flowchart for a system configured to orchestrate transmittal of the transcription output after speech segments have been punctuated.

FIG. 4A illustrates a flowchart for a system configured to orchestrate transmittal of the transcription output before speech segments have been punctuated.

FIG. 4B illustrates another example embodiment of an orchestrator which comprises an integrated punctuator.

FIG. 5A illustrates a user display configured to display speech transcriptions based on different sentiments that are associated with the speech transcriptions.

FIG. 5B illustrates a user display configured to display speech transcriptions based on different speaker roles that are associated with different speakers of the speech transcriptions.

FIG. 5C illustrates a user display configured to display speech transcriptions based on an action item associated with the speech transcriptions.

FIG. 5D illustrates a user display configured to display speech transcriptions with links to external content associated with the speech transcriptions.

FIGS. 6A-6B illustrate various examples and/or stages of a flowchart for a system configured to orchestrate transmittal of the transcription output when the input audio speech is associated with multiple speakers.

FIGS. 7A-7B illustrate various examples for displaying and dispersing transcriptions corresponding to different speakers.

FIG. 8A-8B illustrates various examples and/or stages of a flowchart for a system configured to refrain from outputting punctuated speech segments until the punctuation has been validated based on waiting a pre-determined number of newly decoded speech tokens.

FIG. 9 illustrates one embodiment of a flow diagram having a plurality of acts for generating improved speech transcriptions by refraining from outputting incomplete speech transcriptions to the user display.

FIG. 10 illustrates one embodiment of a flow diagram having a plurality of acts for generating improved speech transcriptions based on delaying the output of punctuated speech segments until the punctuation has been validated by waiting a pre-determined number of newly decoded words.

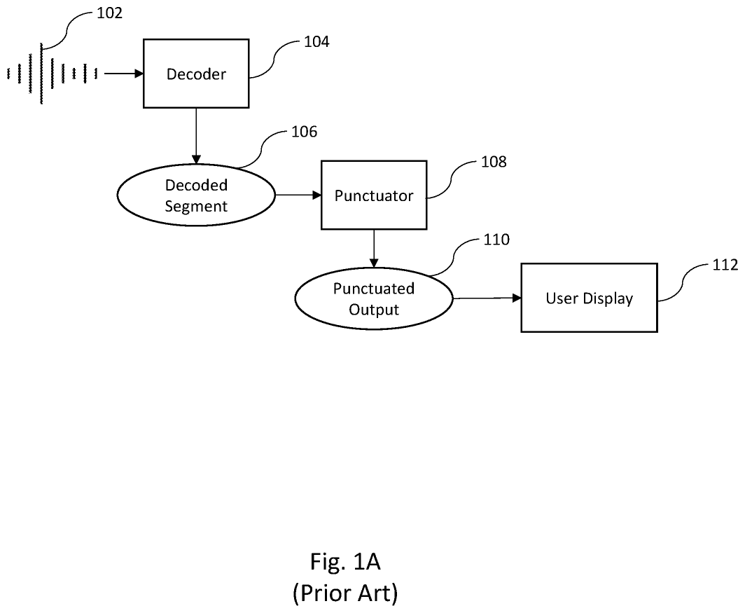

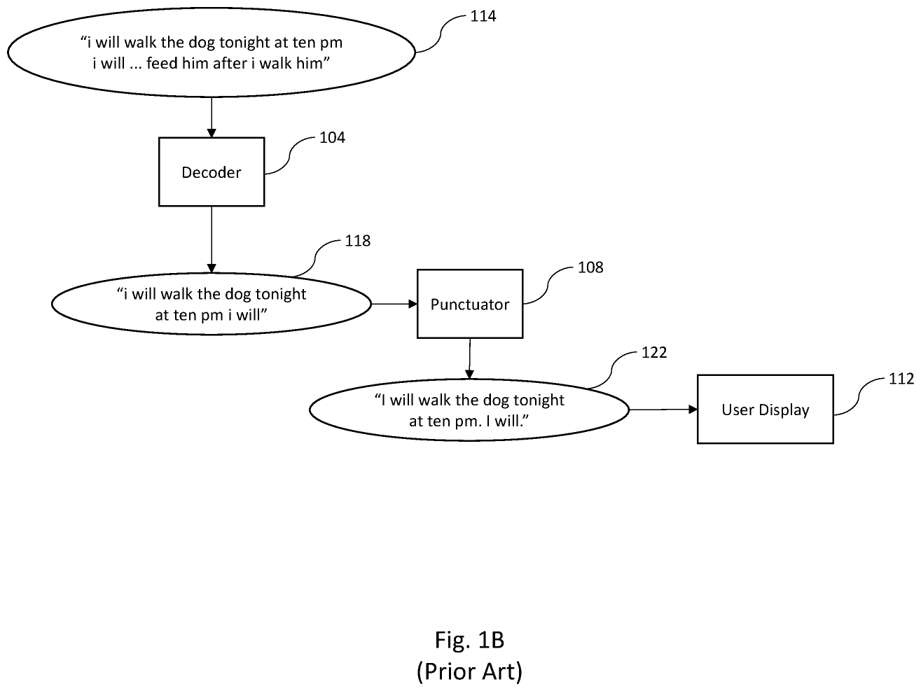

### DETAILED DESCRIPTION

Disclosed embodiments are directed towards systems and methods for generating transcriptions of audio data. In this regard, it will be appreciated that some of the disclosed embodiments are specifically directed to improved systems and methods for improving segmentation and punctuation of the transcriptions of the audio data by refraining from outputting incomplete linguistic segments. In at least this regard, the disclosed embodiments provide technical benefits and advantages over existing systems that are not adequately trained for generating transcriptions from audio data and/or that generate errors when generating transcriptions due to over-segmentation or under-segmentation of the transcriptions.

Cognitive services, such as ASR systems, cater to a diverse range of customers. Each customer wants to optimize their experience against latency, accuracy, and cost of goods sold (COGS). Improvement of segmentation is key to influencing punctuating as the two are closely related. Many existing systems that comprise powerful neural network-based approaches incur high latency and/or COGS. These models are thus not possible to be used for customers that are latency sensitive (e.g., as in streaming audio applications). Even for customers that are latency tolerant, the existing speech recognition services produce mid-sentence breaks after long segments of uninterrupted speech (over-segmentation). This degrades readability when such breaks occur.

However, semantic segmentors, such as those included in disclosed embodiments herein, enable significant readability improvement with no degradation in accuracy while improving the rendering of individual sentences much faster when compared with current production. Thus, disclosed embodiments realize significant improvements for all word-based languages even without neural models for segmentation. Furthermore, this further improves the machine translation performance.

One advantage of the disclosed embodiments is that they deliver significant improvement in readability of closed-captioning services. The semantic segmentor furthermore allows orchestration of different segmentation techniques in the speech backend and punctuation techniques in the display post processing service. Depending on the customers constraints, users can select from different parameters in order to customize a tradeoff between latency, accuracy, and COGs. Such an approach allows a system/service level combination of best of both the worlds (segmentation and punctuation) given customer constraints.

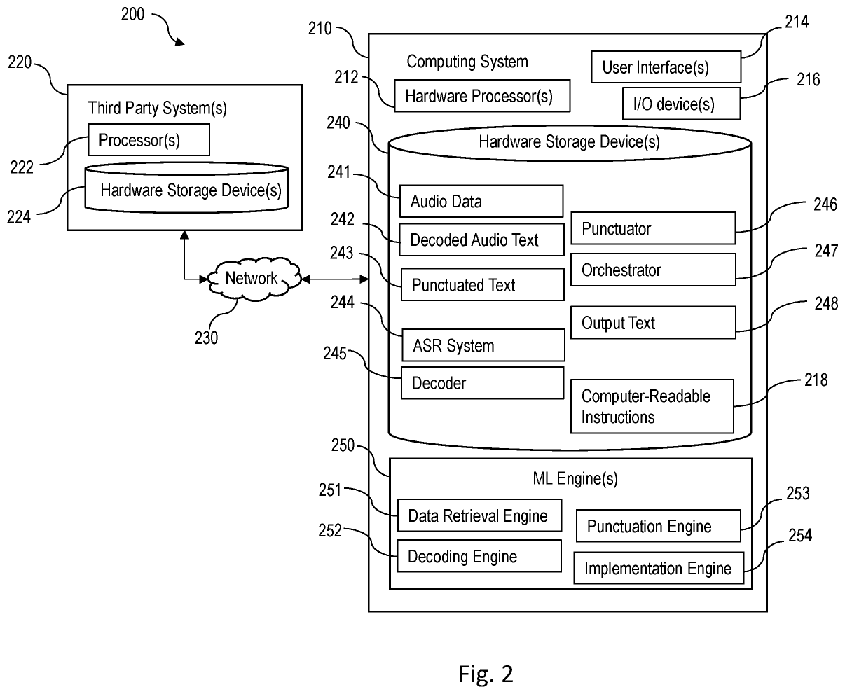

Attention will now be directed to FIG. 2, which illustrates a computing environment 200 that also includes third-party system(s) 220 in communication (via network 230) with a computing system 210, which incorporates and/or is utilized to perform disclosed aspects of the disclosed embodiments. Third-party system(s) 220 includes one or more processor(s) 222 and one or more hardware storage device(s) 224.

The computing system 210, for example, includes one or more processor(s) (such as one or more hardware processor(s) 212) and a storage (i.e., hardware storage device(s) 240) storing computer-readable instructions 118 wherein one or more of the hardware storage device(s) 240 is able to house any number of data types and any number of computer-executable instructions 218 by which the computing system 210 is configured to implement one or more aspects of the disclosed embodiments when the computer-executable instructions 218 are executed by the one or more processor(s) 212. The computing system 210 is also shown including user interface(s) 214 and input/output (I/O) device(s) 216.

As shown in FIG. 2, hardware storage device(s) 240 is shown as a single storage unit. However, it will be appreciated that the hardware storage device(s) 240 is, a distributed storage that is distributed to several separate and sometimes remote systems and/or third-party system(s) 220. The computing system 210 can also comprise a distributed system with one or more of the components of computing system 210 being maintained/run by different discrete systems that are remote from each other and that each perform different tasks. In some instances, a plurality of distributed systems performs similar and/or shared tasks for implementing the disclosed functionality, such as in a distributed cloud environment.

The hardware storage device(s) 240 are configured to store and/or cache in a memory store the different data types including audio data 241, decoded audio text 242, punctuated text 243, and output text 248, as described herein. The storage (e.g., hardware storage device(s) 240) includes computer-readable instructions 118 for instantiating or executing one or more of the models and/or engines shown in computing system 210 (e.g., ASR system 244, decoder 245, punctuator 246, and orchestrator 247). Audio data 241 is input to the decoder 245. Decoded audio text 242 is the output from the decoder 245. Punctuated text 243 is output from the punctuator 246, and output text 248 is output from the orchestrator 247.

The models/model components are configured as machine learning models or machine learned models, such as deep learning models and/or algorithms and/or neural networks. In some instances, the one or more models are configured as engines or processing systems (e.g., computing systems integrated within computing system 210), wherein each engine comprises one or more processors (e.g., hardware processor(s) 212) and computer-executable instructions 218 corresponding to the computing system 210. In some configurations, a model is a set of numerical weights embedded in a data structure, and an engine is a separate piece of code that, when executed, is configured to load the model, and compute the output of the model in context of the input audio.

The audio data 241 comprises both natural language audio and simulated audio. The audio is obtained from a plurality of locations and applications. In some instances, natural language audio is extracted from previously recorded or downloaded files such as video recordings having audio or audio-only recordings. Some examples of recordings include videos, podcasts, voicemails, voice memos, songs, etc. Natural language audio is also extracted from actively streaming content which is live continuous speech such as a news broadcast, phone call, virtual or in-person meeting, etc. In some instances, a previously recorded audio file is streamed. Audio data comprises spoken language utterances with or without a corresponding clean speech reference signal. Natural audio data is recorded from a plurality of sources, including applications, meetings comprising one or more speakers, ambient environments including background noise and human speakers, etc. It should be appreciated that the natural language audio comprises one or more spoken languages of the world's spoken languages.

An additional storage unit for storing machine learning (ML) Engine(s) 250 is presently shown in FIG. 2 as storing a plurality of machine learning models and/or engines. For example, computing system 210 comprises one or more of the following: a data retrieval engine 251, a decoding engine 252, a punctuation engine 253, and an implementation engine 254, which are individually and/or collectively configured to implement the different functionality described herein.

For example, the data retrieval engine 251 is configured to locate and access data sources, databases, and/or storage devices comprising one or more data types from which the data retrieval engine 251 can extract sets or subsets of data to be used as training data. The data retrieval engine 251 receives data from the databases and/or hardware storage devices, wherein the data retrieval engine 251 is configured to reformat or otherwise augment the received data to be used in the speech recognition and segmentation tasks. Additionally, or alternatively, the data retrieval engine 251 is in communication with one or more remote systems (e.g., third-party system(s) 220) comprising third-party datasets and/or data sources. In some instances, these data sources comprise visual services that record or stream text, images, and/or video.

The data retrieval engine 251 accesses electronic content comprising audio data 241 and/or other types of audio-visual data including video data, image data, holographic data, 3-D image data, etc. The data retrieval engine 251 is a smart engine that is able to learn optimal dataset extraction processes to provide a sufficient amount of data in a timely manner as well as retrieve data that is most applicable to the desired applications for which the machine learning models/engines will be used.

The data retrieval engine 251 locates, selects, and/or stores raw recorded source data wherein the data retrieval engine 251 is in communication with one or more other ML engine(s) and/or models included in computing system 210. In such instances, the other engines in communication with the data retrieval engine 251 are able to receive data that has been retrieved (i.e., extracted, pulled, etc.) from one or more data sources such that the received data is further augmented and/or applied to downstream processes. For example, the data retrieval engine 251 is in communication with the decoding engine 252 and/or implementation engine 254.

The decoding engine 252 is configured to decode and process the audio (e.g., audio data 241). The output of the decoding engine is acoustic features and linguistic features and/or speech labels. The punctuation engine 253 is configured to punctuate the decoded segments generated by the decoding engine 252, including applying other formatting such as capitalization, and/or text/number normalizations.

The computing system 210 includes an implementation engine 254 in communication with any one of the models and/or ML engine(s) 250 (or all of the models/engines) included in the computing system 210 such that the implementation engine 254 is configured to implement, initiate, or run one or more functions of the plurality of ML engine(s) 250. In one example, the implementation engine 254 is configured to operate the data retrieval engine 251 so that the data retrieval engine 251 retrieves data at the appropriate time to be able to obtain audio data 241 for the decoding engine 252 to process. The implementation engine 254 facilitates the process communication and timing of communication between one or more of the ML engine(s) 250 and is configured to implement and operate a machine learning model (or one or more of the ML engine(s) 250) which is configured as an automatic speech recognition system (ASR system 244).

The implementation engine 254 is configured to implement the decoding engine 252 to continuously decode the audio. Additionally, the implementation engine 254 is configured to implement the punctuation engine to generate punctuated segments.

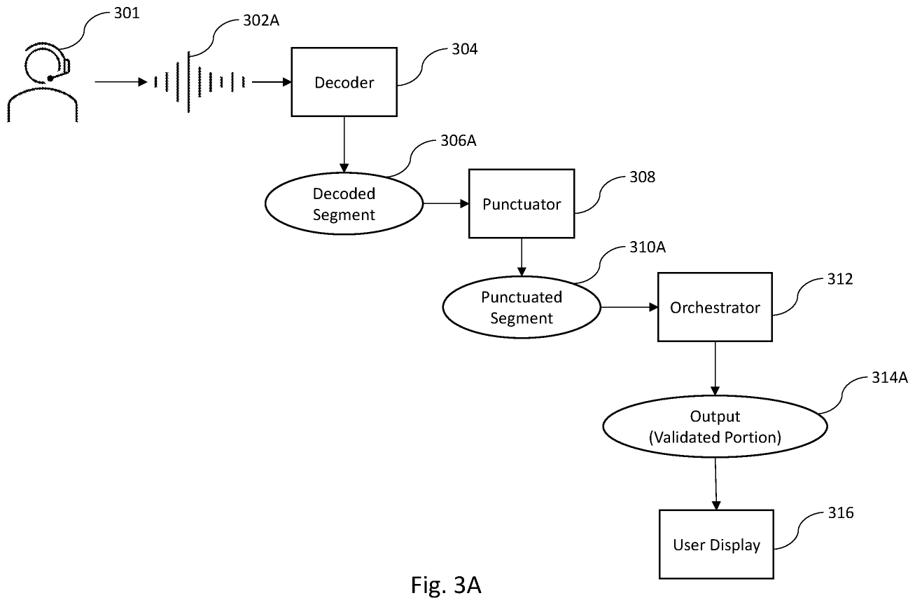

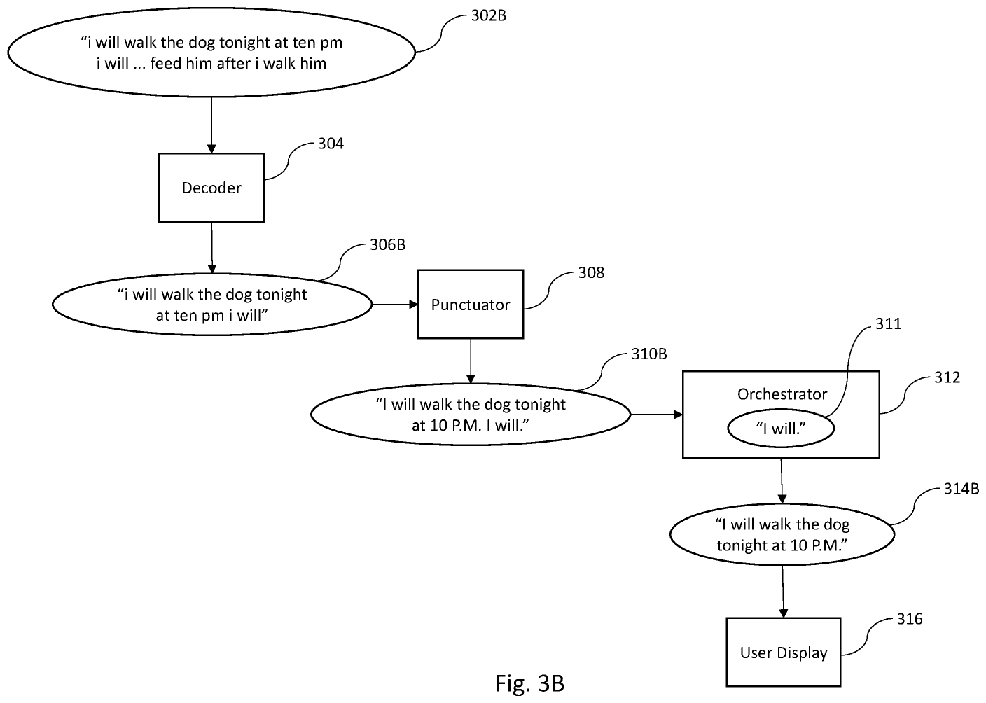

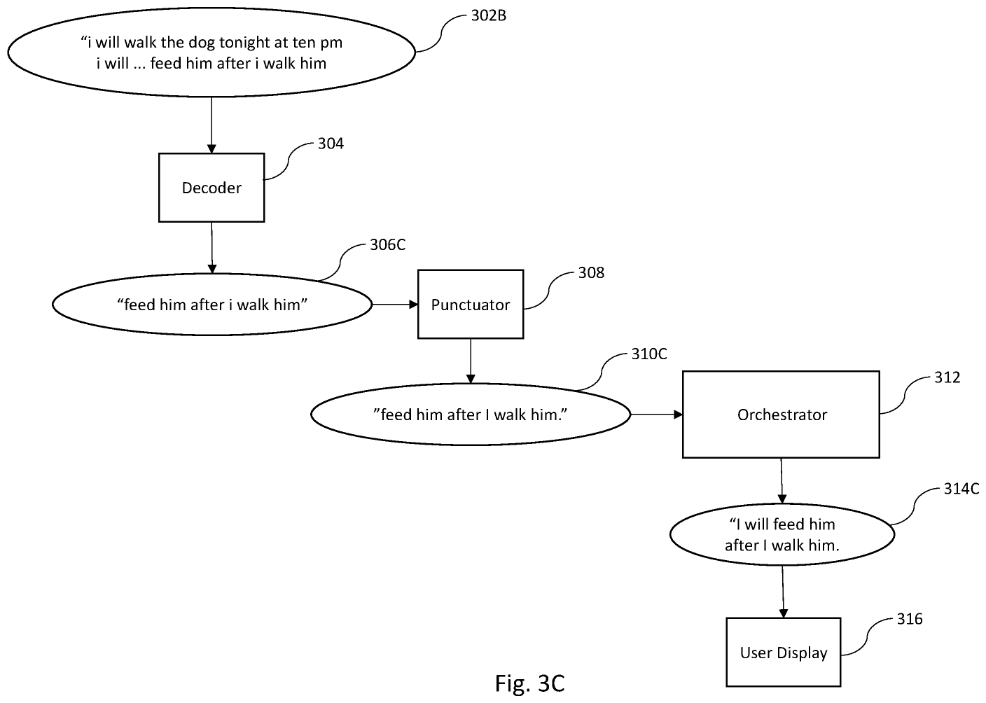

Attention will now be directed to FIGS. 3A-3C, which illustrate various examples and/or stages of a flowchart for a system configured to orchestrate transmittal of the transcription output after speech segments have been punctuated. FIGS. 3A-3C are shown having a decoder 304, a punctuator 308, an orchestrator 312, and a user display 316. Attention will first be directed to FIG. 3A, wherein the decoder 304 is configured to decode spoken language utterances recognized in input audio (e.g., streaming audio data 302A) associated with speaker 301 in order to generate decoded audio segments (e.g., decoded segment 306A). In some instances, the decoded segment comprises speech data representations and/or speech data transcriptions (i.e., speech token labels). The decoded segments are then punctuated by the punctuator 308 at one or more linguistic boundaries identified within the decoded segment. In some instances, the decoder 304 is configured to identify the linguistic boundaries. Additionally, or alternatively, the punctuator 308 is configured to identify a linguistic boundary within the decoded segments and/or confirm a linguistic boundary previously identified by the decoder. In some instances, linguistic boundaries are detected in the streaming audio data prior to being transcribed by the decoder.

As described herein, a linguistic boundary is representational marker identified and/or generated at the end of a complete sentence. In some instances, a linguistic boundary exists at the end of a complete sentence, typically just after the end of the last word of the sentence. Based on the linguistic boundary, correct punctuation can be determined. For instance, punctuation is desirably placed at the linguistic boundary (i.e., just after the last word of the sentence). Additionally, a text or audio segment can be further segmented into at least one portion which includes a complete sentence and a second portion which may or may not include another complete sentence. It should be appreciated that linguistic boundaries can also be detected at the end of audio or text phrases which a speaker or writer has intentionally spoken or written as a sentence fragment. In some instances, the linguistic boundary is predicted when a speaker has paused for a pre-determined amount of time. In some instances, the linguistic boundary is determined based on context of the first segment (or first portion of the segment) in relation to a subsequent segment (or subsequent portion of the same segment). In yet other embodiments, a linguistic boundary is the logical boundary found at the end of a paragraph. In other instances, more than one linguistic boundary exists within a single sentence, such as at the end of a phrase or statement within a single sentence that contains multiple phrases or statements.

Once the decoded segment 306A has been punctuated by the punctuator 308, the punctuated segment 310A is analyzed by the orchestrator 312 which is configured to detect one or more portions of the punctuated segment 310A which are correctly segmented and punctuated portions (e.g., complete sentences) and only output the completed sentences (e.g., output 314A) to the user display 316.

Some example user displays, or user interfaces, include audio-visual displays such as television or computer monitors. Exemplary displays also include interactable displays, such as tablets and/or mobile devices, which are configured to both display output as well as to receive and/or render user input. In some instances, the output that is rendered on the display is displayed dynamically, temporarily, and contemporaneously or simultaneously with other corresponding content that is being processed and rendered by the output device(s), such as in the case of live captioning of streaming audio/audio-visual data. In other instances, transcribed outputs are aggregated and appended to previous outputs, with each output being displayed as part of the in-progress transcript as outputs are generated. Such transcripts could be displayed via a scrollable user interface. In some instances, outputs are displayed only when all final outputs (i.e., correctly segmented and punctuated outputs) have been generated and in which the entire corrected transcript is rendered as a batched final transcript. A batched final transcript, for example, can be useful when a long audio timeout causes an abrupt break in a sentence (one that is not intended for the transcript) and which results in unnatural sentence fragments. In such scenarios, the orchestrator and/or punctuator can operate to verify the punctuation and ensure that the sentence fragments are stitched together prior to being transmitted to an output device in the final format of a batched transcript.

In some instances, the output 314A comprise grammatically complete sentences, while in some instances, the output 314A comprise grammatically incomplete or incorrect transcriptions, but that are still correctly segmented and punctuated because the output 314A comprises portions of the initially decoded segment which correspond to intentional sentence fragments and/or intentional run-on sentences. In some instances, the decoded segment 408 comprises a single complete sentence, multiple complete sentences, a partial sentence, or a combination of complete and partial sentences in any sequential order.

Attention will now be directed to FIG. 3B which illustrates an example of input audio being processed by the automatic speech recognition system depicted in FIG. 3A. For example, streaming audio data 302B is obtained which comprises the spoken language utterance “i will walk the dog tonight at ten pm i will feed him after i walk him”. The decoder 304 decodes a first segment of audio and outputs a decoded segment 306B comprising “i will walk the dog tonight at ten pm i will”. In this instance, the streaming audio data was initially segmented in this manner due to a pause (i.e., speaker silence) denoted in the input audio data by “ . . . ”. The punctuator 308 then punctuates this decoded segment and outputs a punctuated segment 310B (e.g., ““I will walk the dog tonight at 10 P.M. I will.”).

The orchestrator 312 is then configured to detect which portions of the punctuated segment are completed segments and output only those one or more portions which are completed sentences. As shown in FIG. 3B, the orchestrator 312 recognizes that “I will walk the dog tonight at 10 P.M.”) is a complete sentence and generates the output 314B corresponding to that first portion of the punctuated segment. The second portion of the punctuated segment (“I will.”, see portion 311) is determined to be an incomplete sentence and is therefore retained in the orchestrator (and/or a storage cache) without being generated as output which can be transmitted to the user display 316. The first portion of the punctuated segment (e.g., output 314B) is transmitted to the user display and presented on the user display.

Attention will now be directed to FIG. 3C, which illustrates a continuation of the speech processing depicted in FIG. 3B. For example, the subsequent portion of the streaming audio data 302A (e.g., “feed him after i walk him”) is decoded by the decoder 304 which generates the decoded segment 306C. The punctuator 308 then punctuates the decoded segment and generates the punctuated segment 310C (e.g., “feed him after I walk him.”) Because the orchestrator retained the previous portion “I will”, the punctuator, in some instances, assumes that the next punctuated segment should not be capitalized as the beginning of new sentence, but rather will be appended to the retained portion of the previous punctuated segment. Thus, the orchestrator 312 generates output 314C (e.g., “I will feed him after I walk him.”). In some instances, when the punctuator 308 has not recognized this connected between punctuated segments or if some punctuation is left over from a previously punctuated segment, overlapping or extraneous punctuation can be corrected and reconciled prior to being displayed on the user display (e.g., the period previously included in the punctuated segment 3108 after “I will.” is removed in the output 314C.

In the case where no linguistic boundary is detected in the initial segment, the computing system refrains from outputting the initial segment of decoded streaming audio data and continues to decode the streaming audio data until a subsequent segment of decoded streaming audio data is generated and appended to the initial segment of decoded streaming audio data. In this manner, the system analyzes the joined segments to determine if a linguistic boundary exists.

In some embodiments, the computing system utilizes a cache which facilitates the improved timing of output of the different speech segments. For example, the system stores the initial segment of decoded streaming audio data in a cache. Then, after outputting the first portion of the initial segment, the system clears the cache of the first portion of the initial segment of the decoded streaming audio data. In further embodiments, while clearing the cache of the first portion of the initial segment of decoded streaming audio data, the system retains the second portion of the segment of decoded streaming audio data in the cache. Embodiments that utilize a cache in this manner improve the functioning of the computing system by efficiently managing the storage space of the cache by deleting data that has already been output and retaining data that will be needed in order to continue to generate accurately punctuated outputs.

For example, when the second portion of the initial segment of decoded streaming audio is retained in the cache, the system is able to store a subsequent segment of decoded streaming audio data in the cache, wherein the subsequent segment of decoded streaming audio data is appended to the second portion of the initial segment of decoded streaming audio data to form a new segment of decoded streaming audio data.

The system then determines whether a subsequent linguistic boundary exists within the new segment of decoded streaming audio data. When a subsequent linguistic boundary is determined to exist, the system applies a new punctuation at the subsequent linguistic boundary and outputs a first portion of the new segment of the streaming audio data ending at the subsequent linguistic boundary while refraining from outputting a second portion of the new segment located temporally subsequent to the second portion of the initial segment.

The disclosed embodiments are directed to systems, methods, and devices which provide for automated segmentation and punctuation, as well as user-initiated segmentation and/or punctuation. For example, the decoder is configurable to generate decoded segments based on a user command and/or detected keyword recognized within the streaming audio data. Similarly, the punctuator is configurable to punctuate a decoded segment based on a user command and/or detected keyword within the decoded segment.

While FIGS. 3A-3C illustrates flow diagrams in which the first portion of the initial segment is output after being punctuated with an initial punctuation, disclosed embodiments are also provided for applying the initial punctuation while (i.e., simultaneously with) outputting the first portion of the initial segment. Additionally, some embodiments are configured to apply the initial punctuation after outputting the first portion of the initial segment of the decoded streaming audio.

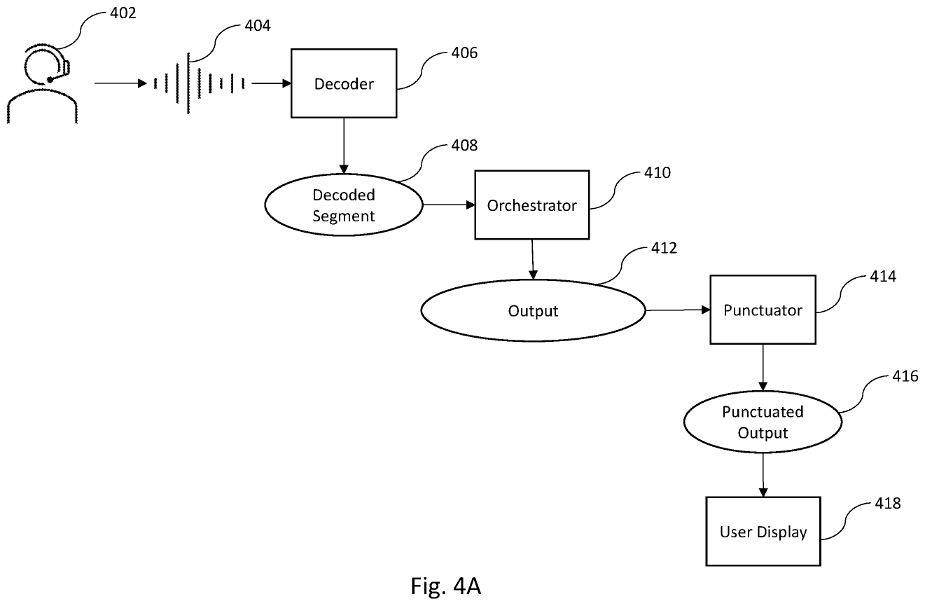

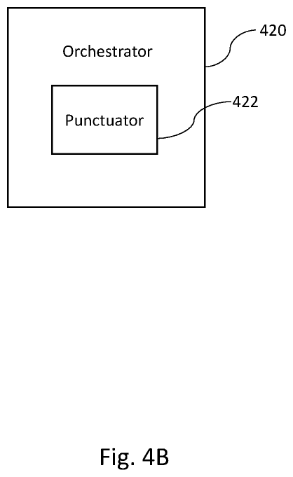

As an example, attention will now be directed to FIG. 4A, which illustrates a flowchart for a system configured to orchestrate transmittal of the transcription output before speech segments have been punctuated. For example, audio data 404 associated with speaker 402 is decoded by decoder 406 which generates decoded segment 408. The orchestrator 410 is able to recognize a first linguistic boundary included in the decoded segment and output the portion of the decoded segment ending at the first linguistic boundary (e.g., output 412). In this manner, the output (comprising a complete sentence) can be transmitted and displayed without punctuation, if desired, wherein portions of the decoded segments are still filtered/throttled at the orchestrator based on identifying and outputting complete sentences and refraining from outputting incomplete sentences. Additionally, or alternatively, this output 412 is then punctuated by the punctuator 414. The punctuated output 416 is then displayed at the user display 418.

Attention will now be directed to FIG. 4B, which illustrates another example embodiment of an orchestrator 420 which comprises an integrated punctuator 422, in which punctuation is applied while outputting the complete sentence recognized in the decoded segment. In this manner, the disclosed embodiments are configured to be flexible in processing different input audio data, wherein the order of segmentation, decoding, punctuation, and outputting can be dynamically changed based on different attributes of the input audio data in order to provide an optimized transcription generation and display at a user display.

There are many different visual formatting modifications that can be made to the segments of decoded streaming audio prior or during their display on the user display. The visual formatting can include type-face formatting (e.g., bold, italicized, underlined, and/or strike-through), one or more fonts, different capitalization schemes, text coloring and/or highlighting, animations, or any combination thereof. While each of the following figures depicts a visual formatting modification corresponding to different typefaces, it will be appreciated that sentiment analysis, speaker role recognition, action item detection, and/or external content linking may be displayed according to any of the aforementioned visual formatting types.

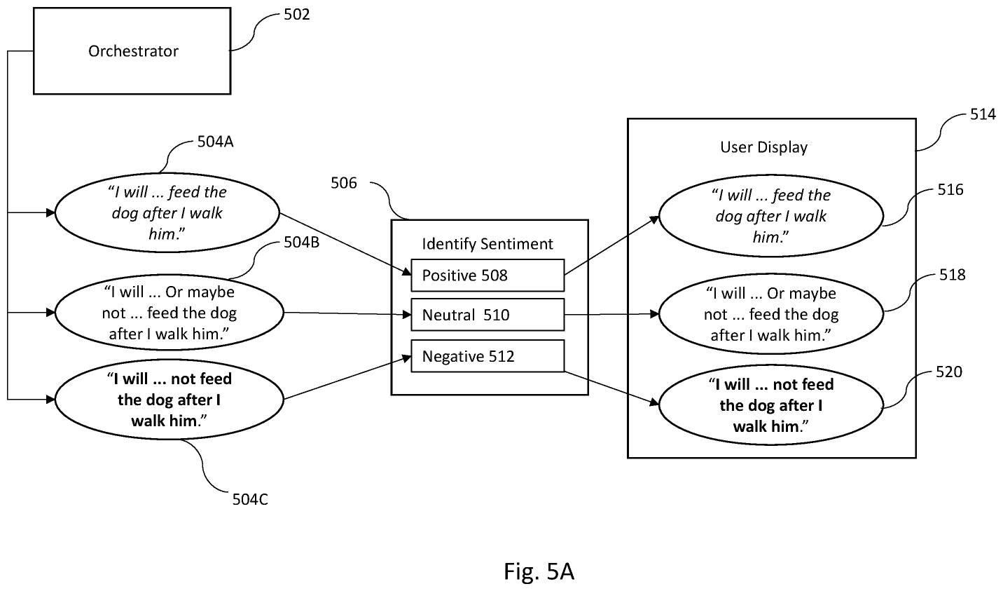

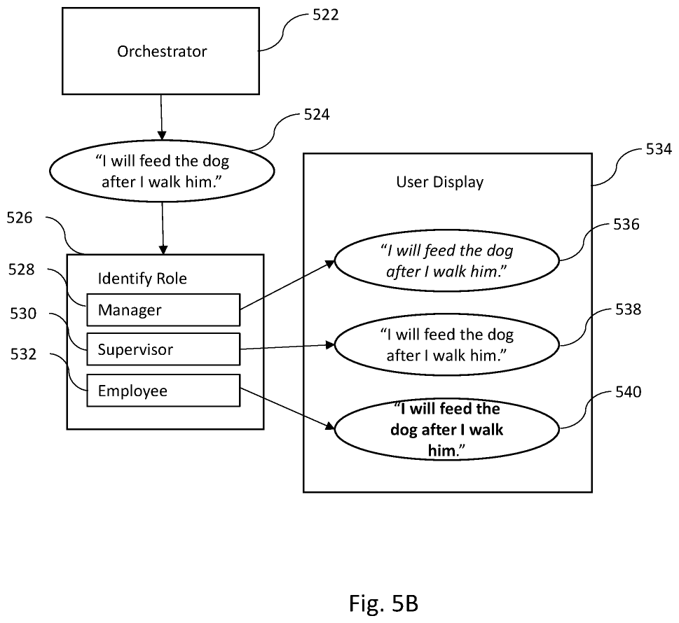

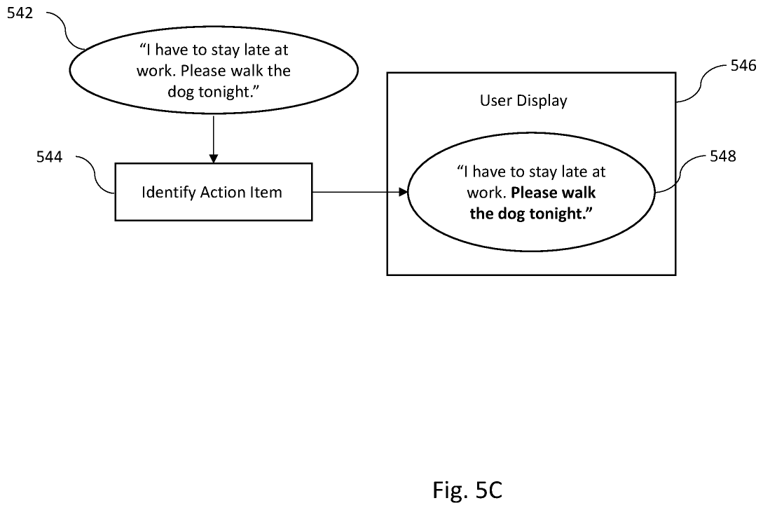

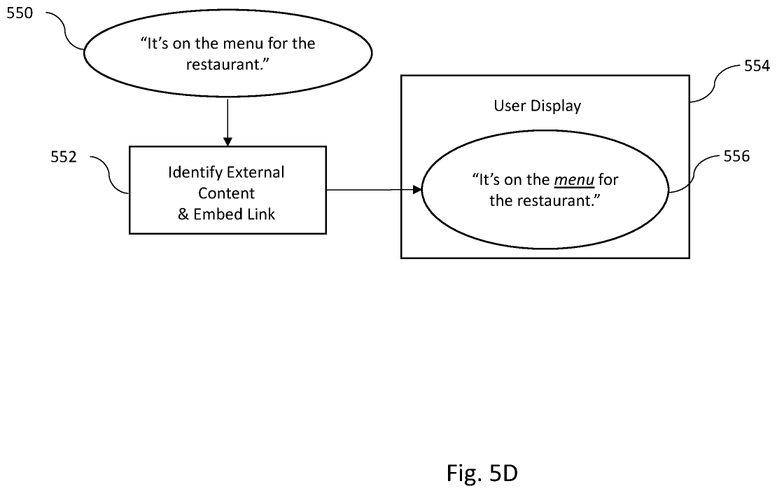

Attention will now be directed to FIGS. 5A-5D, which illustrates different visual text formatting. As illustrated in FIG. 5A, a user display is shown to display speech transcriptions based on different sentiments that are associated with the speech transcriptions. The disclosed systems recognize a sentiment associated the first portion of the initial segment of decoded streaming audio data and apply a visual formatting corresponding to the sentiment associated with the first portion of the initial segment of decoded streaming audio data to the first portion of the initial segment of decoded streaming audio data, wherein a different visual formatting is applied to a different sentiment detected for a different portion of decoded streaming audio data.

For example, after the orchestrator 502 generates one or more of the different outputs 504A (e.g., “I will feed the dog after I walk him.”), output 504B (e.g., “I will . . . or maybe not . . . feed the dog after I walk him.”), and output 504C (e.g., “I will . . . not feed the dog after I walk him.”) which has already been punctuated and confirmed to each be a complete sentence, the system is configured to identify a sentiment (e.g., identify sentiment 506) associated with output 504. As shown in FIG. 5A, the sentiment can be determined to be a positive sentiment 508, a neutral sentiment 510, or a negative sentiment 512. A visual formatting is then assigned and/or applied to the output (e.g., 504A, 504B, 504C) wherein the output can be displayed on the user display 514 using the assigned visual formatting.

By implementing systems in this manner, sentiment recognition can be greatly improved. For example, initially, in each of the different outputs, the sentence began with the incomplete phrase “I will” which was initially segmented due to the pause (indicated by “ . . . ”). However, the orchestrator refrained from outputting the incomplete sentence “I will” until the next segment for the corresponding initial segment had been decoded. Thus, the system did not attempt to detect sentiment on the first segment, which would have yielded an incorrect sentiment based on an incomplete sentence. Rather, the system analyzed the complete output and is able to more accurately predict sentiment. Additionally, this improves computer functioning by more efficiently analyzing for sentiment because the system does not run a sentiment analysis on the same segment or same portion of the segment multiple times.

For example, if the sentiment is identified as a positive sentiment, the sentence is presented in an italicized typeface (e.g., sentence 516). If the sentiment is identified as a neutral sentiment, the sentence is presented in a regular typeface (e.g., sentence 518). If the sentiment is identified as a negative sentiment, the sentence is presented in a bold typeface (e.g., sentence 520). In some instances, sentiments correspond to an emotion that the user is likely to be experiencing based on attributes of their spoken language utterances.

Additionally, or alternatively, different sentiments could also trigger different user alerts or notifications or could trigger involvement of additional users. For example, if the primary user is a person communicating with a help chat automated bot and a negative sentiment is detected, the system generates an alert to a customer service representative who can override the automated chat bot and begin chatting with the chat bot directly. In another example, if a primary user is a customer chatting with a customer service representative and a positive sentiment is detected, the system generates a notification to the manager of the customer service representative which highlights a good job that the customer service representative is doing in communicating with the customer. Alternatively, a system administrator may have access to the user display which is displaying the different visual formatting and can provide necessary intervention based on viewing a visual formatting associated with a non-neutral sentiment.

Attention will now be directed to FIG. 5B. The disclosed embodiments identify a speaker role attributed to a speaker of the first portion of the initial segment of decoded streaming audio data and apply a visual formatting corresponding to the speaker role attributed to the speaker of the first portion of the initial segment of decoded streaming audio data, wherein a different visual formatting is applied to decoded streaming audio data attributed to a different speaker role.

As illustrated in FIG. 5B, a user display is configured to display speech transcriptions based on different speaker roles that are associated with different speakers of the speech transcriptions. Once the orchestrator 522 generates output 524, the system is able to identify a speaker role (e.g., identify role 526) associated with the speaker from which the output 524 originated. For example, if the speaker was a manager 528, the output 524 is displayed as output 536 (e.g., with a visual formatting comprising italicized text). If the speaker was a supervisor 530, the output 524 is displayed as output 538 (a visual formatting comprising regular type-face text). If the speaker was an employee 532, the output 524 is displayed as output 540 (a visual formatting comprising a bold-face text) at the user display 534.

Attention will now be directed to FIG. 5C associated with embodiments that identify an action item within the first portion of the initial segment of decoded streaming audio data and apply a visual formatting corresponding to the action item associated with the first portion of the initial segment of decoded streaming audio data to the first portion of the initial segment of decoded streaming audio data, wherein different visual formatting is applied to decoded streaming audio data associated with a different action item at the user display.

As illustrated in FIG. 5C, a user display is configured to display speech transcriptions based on an action item associated with the speech transcriptions. For example, output 542 (e.g., “I have to stay late at work. Please walk the dog tonight.”) is analyzed and an action item (e.g., “walk the dog”) is identified (e.g., Identify Action Item 544). The portion of the output 542 which corresponds to the action item is presented in a different visual formatting than the portions which do not include an action item. In this manner, the user display 546 displays the formatted output 548 as “I have to stay late at work.” in regular typeface and “Please walk the dog tonight.” in bold typeface.

As illustrated in FIG. 5D, w a user display is configured to display speech transcriptions with links to external content associated with the speech transcriptions. The disclosed systems identify external content associated with the first portion of the initial segment of decoded streaming audio data, embed a link within the first portion of the initial segment of decoded streaming audio data to the first portion of the initial segment of decoded streaming audio data, wherein the link directs a user to the external content; and display the link as a selectable object at the user display.

As illustrated in FIG. 5D, the system recognizes that there is external content related to output 550 (e.g., “It's on the menu for the restaurant.”). The system identifies the external content, in this case the online menu for the restaurant, and embeds a link in the word(s) most closely corresponding to the external content (e.g., a link is embedded in the word menu). See identify external content and embed link, action 552. This link is displayed at the user display 554 as a selectable object which is visually identifiable by the word “menu” being modified (e.g., displayed in italicized and underlined text) from the original text included in output 550 and distinct from the rest of the text included in the displayed output 556.

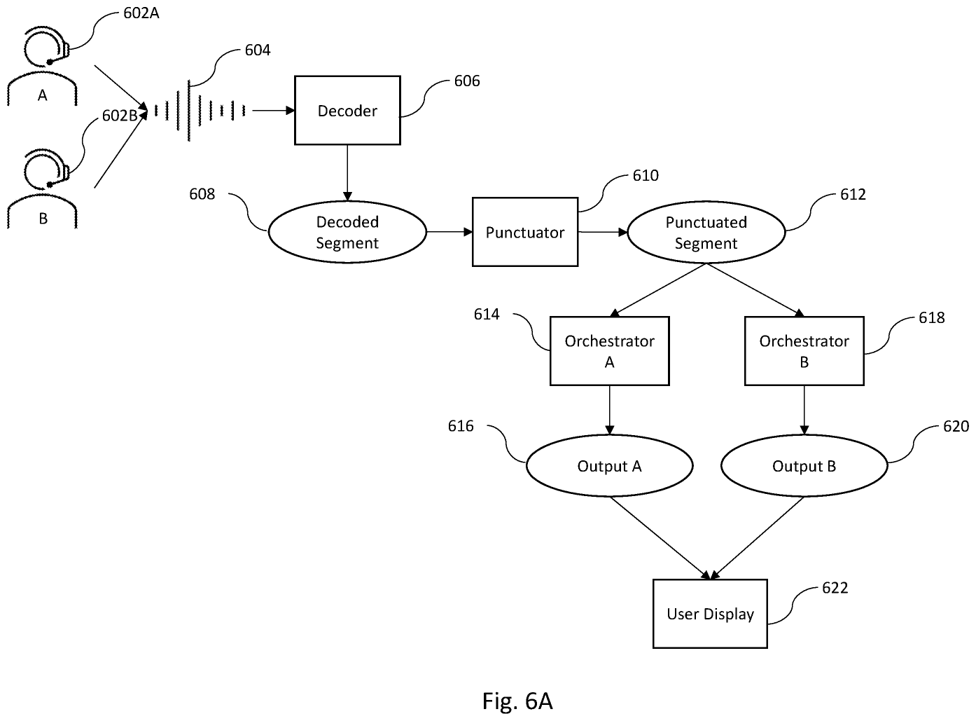

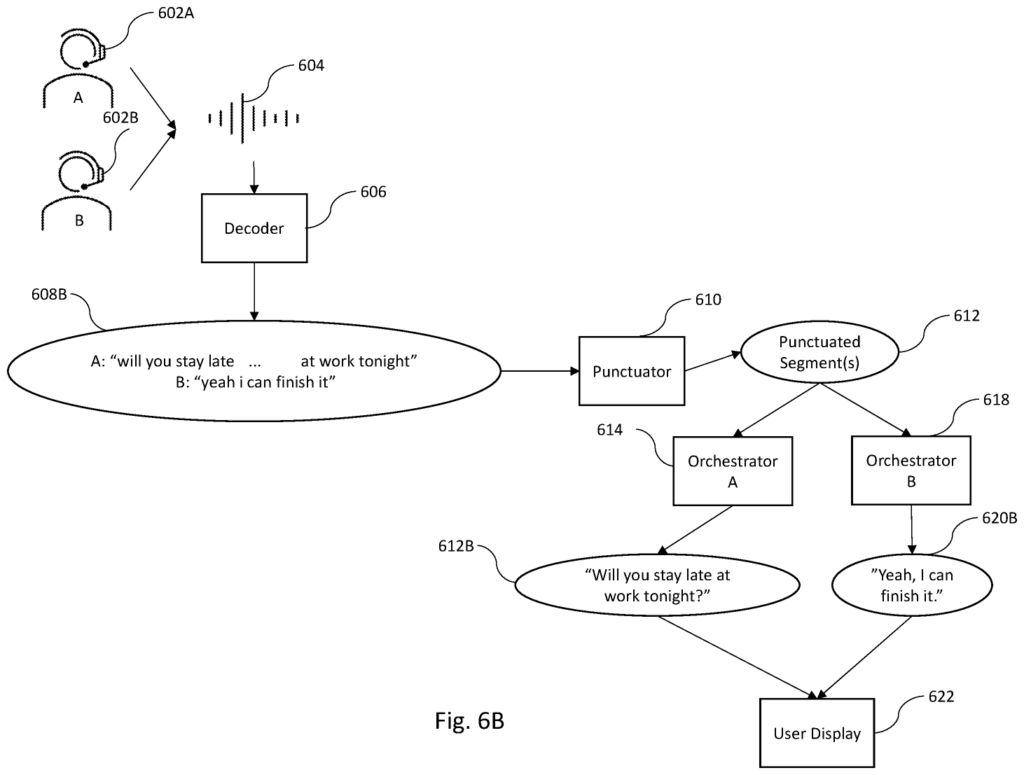

Attention will now be directed to FIGS. 6A-6B, which illustrate various examples and/or stages of a flowchart for a system configured to orchestrate transmittal of the transcription output when the input audio speech is associated with multiple speakers. As illustrated in FIGS. 6A-6B, disclosed embodiments are provided for obtaining streaming audio data comprising language utterances from multiple speakers and multiple audio input devices, wherein the streaming audio data is separated into a plurality of audio data streams according to each audio input device such that each audio data stream and each audio stream is analyzed by a different orchestrator.

For example, audio data 604 is obtained from multiple speakers (e.g., speaker A and speaker B) who are using different input audio devices (e.g., headphone 602A and headphone 602B, respectively). The audio data 604 is decoded by the decoder 606 in the order in which the different language utterances are spoken by the different speakers. Alternatively, multiple decoders are used, such that each speaker is assigned a different decoder. The decoder 606 then generates a decoded segment 608 which is a segment of audio and/or a transcribed segment of audio included in the audio data 604. The decoded segment 608 is then punctuated by punctuator 610. The punctuated segment 612 is then filtered based on which portion of the punctuated segment 612 corresponds to which speaker. Portions of punctuated segment 612 that correspond to speaker A are transmitted to orchestrator 614 and portions of punctuated segment 612 that correspond to speaker B are transmitted to orchestrator 618. Orchestrator 614 then generates output 616, and orchestrator 618 generates output 620. In similar manner to the system depicted in FIG. 3A, the output from the orchestrator comprises complete sentences, while the orchestrator refrains from outputting incomplete sentences. These orchestrator outputs are then sent to the user display 622.

Attention will now be directed to FIG. 6B, which illustrates an example of audio being processed by the system depicted in. FIG. 6A. For example, the decoder 606 generates a decoded segment 608 comprising “will you stay late-yeah i can finish-at work-it-tonight”, which has been modified in this instance with dashes to emphasize the overlapping nature of the speech by the multiple speakers. As shown in FIG. 6B, speaker A paused between “late” and “at”, wherein speaker B interjected/interrupted speaker A and answered, “yeah i can finish it”. Speaker A finished speaking after their pause, towards the end of speaker B's answer (e.g., “at work tonight”). This decoded segment 608B is punctuated by the punctuator 610 to generate one or more punctuated segments organized by speaker.

The punctuated segment comprising “Will you stay late” is sent to the orchestrator, which recognizes that it is not a complete sentence. Thus, the orchestrator 614, which is associated with speaker A, waits for the subsequent punctuated segment “at work tonight?”, appends the subsequent punctuated segment to the first punctuated segment, and then generates output 612B “(e.g., Will you stay late at work tonight?”) which is complete sentence. On the other hand, orchestrator 618 receives the portion of the punctuated segment which corresponds to speaker B and generates output 620B (e.g., “Yeah, I can finish it.”), which is a complete sentence. These complete sentences are then sent to the user display 622.

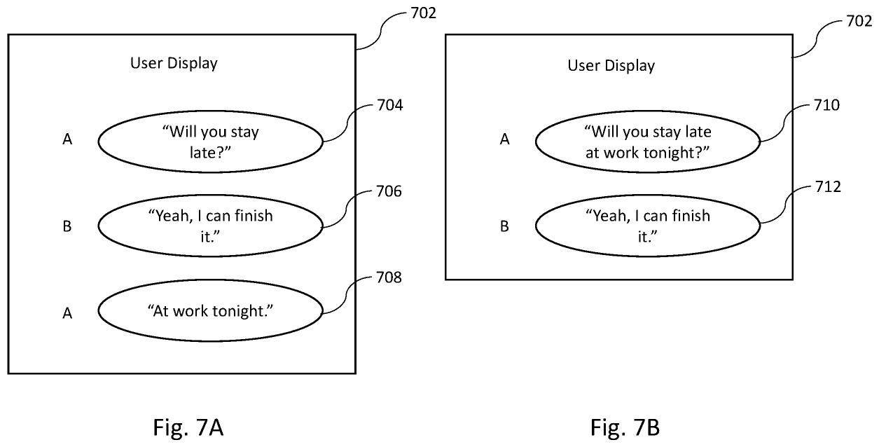

Attention will now be directed to FIGS. 7A-7B, which illustrate various examples for displaying and dispersing transcriptions corresponding to different speakers on a user display. In some instances, the disclosed systems obtain multiple outputs from different speakers and display the outputs in sequential order. For example, as shown in FIG. 7A, the user display 702 displays outputs from speaker A and speaker B sequentially (e.g., first output 704 comprising “Will you stay late?” from speaker A, second output 706 comprising “Yeah, I can finish it.” from speaker B, and third output 708 comprising “At work tonight.” from speaker A.)

Alternatively, the systems obtain multiple outputs from different speakers and combine the outputs according to each of the different speakers (see FIG. 7B). As shown in FIG. 7B, the user display 702 is shown presenting a first output 710 associated with speaker A and a second output 712 associated with speaker B. This manner of displaying speech transcriptions is enabled by the use of one or more orchestrators which does not output a transcription until it has confirmed that the output is a complete sentence. Such a display is an improvement over conventional displays of speech transcriptions because it provides improved transcriptions, more accurate segmentation and punctuation, and improved readability on the user display (i.e., it reduces confusion when a reader is reading text based on audio from multiple speakers).

In some embodiments, the systems are configured to obtain multiple outputs and combine the multiple outputs into a paragraph prior to transmitting the outputs as an output for display. This type of combining is beneficial when the output application is a final transcript which is intended to be read later, or after text has been displayed as part of closed captioning of streaming audio.

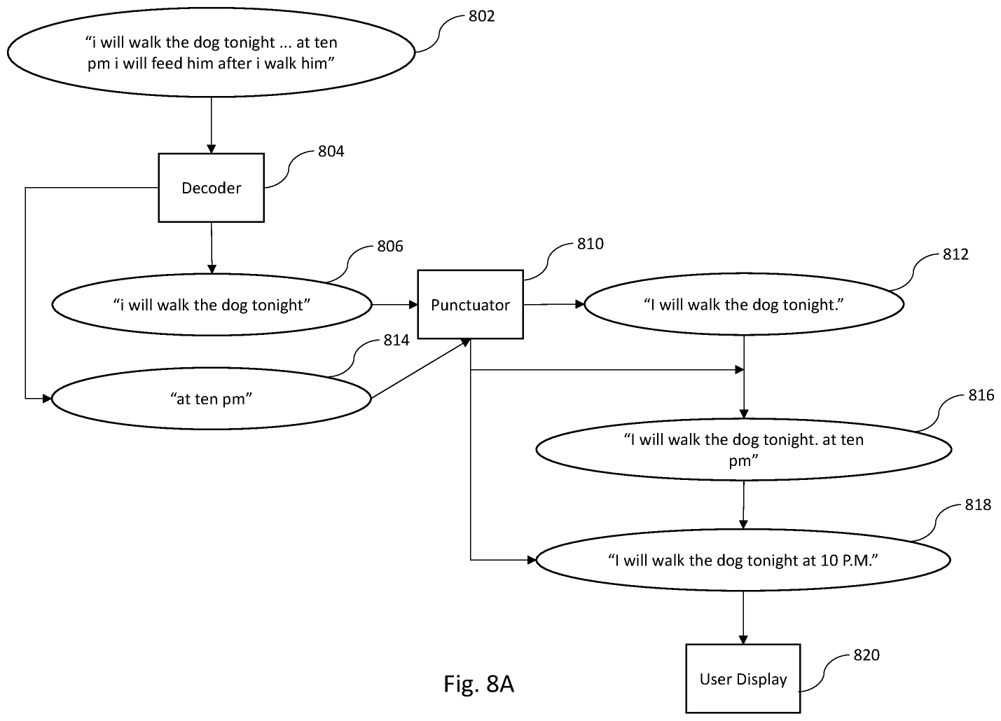

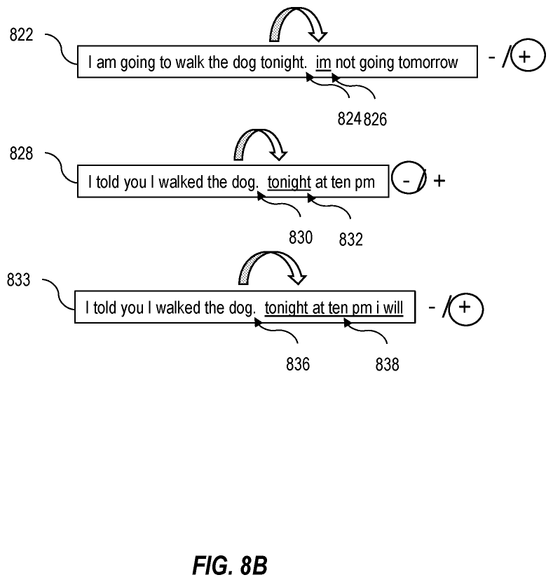

Attention will now be directed to FIG. 8A-8B, which illustrates various examples and/or stages of a flowchart for a system configured to refrain from outputting punctuated speech segments until the punctuation has been validated based on waiting a pre-determined number of newly decoded speech tokens. The system illustrated in FIG. 8A includes a decoder 804 which is configured to decode spoken language utterances and generate a transcription of the spoken language utterances, a punctuator 810 which is configured to punctuate the transcription based on an identified linguistic boundary within the transcription of the spoken language utterances, and an intermediary orchestrator which is configured to hold a portion of the transcription until the initial punctuation is validated.

As illustrated in FIG. 8A, audio data 802 comprising the spoken language utterances “i will walk the dog tonight . . . at ten pm i will feed him after I walk him” is decoded by decoder 804. It should be appreciated that in some instances, the audio data is streaming audio data, while other instance, the audio is a pre-recorded set of audio data.

The decoder 804 initially decodes the first portion of audio data 802 and generates a decoded segment 806 comprising “i will walk the dog tonight”. This decoded segment 806 is then punctuated by the punctuator 810 to generate a punctuated segment 812 comprising “I will walk the dog tonight.” However, prior to outputting the punctuated segment to the user display 820, the system waits a pre-determined number of tokens (e.g., words) in order to validate whether the initial punctuation provided for the punctuated segment 812 is the correct punctuation.

In this instance, the system is configured to decode an additional three words. Thus, the decoder 804 continues to decode the audio data 802 and generates a subsequent decoded segment 814 comprising “at ten pm”. This subsequent decoded segment 814 is appended to the punctuated segment 812 to form segment 816, wherein the system determines if the initial punctuation was correct. As shown in FIG. 8A, the system determines that the initial punctuation was not correct, as the words “at ten pm” should have been included to complete the sentence. The initial punctuation is then altered to generate corrected punctuated segment 818 comprising “I will walk the dog tonight at 10 P.M.” This corrected punctuated segment 818 is then sent to the user display.

Thus, when the initial punctuation is correct, the systems transmit the first portion of the initial segment of the streaming audio data to a user display and display the first portion of the initial segment including the initial punctuation. However, upon determining that the initial punctuation is not correct, the systems remove the initial punctuation from the initial segment of the decoded streaming audio data and refrain from outputting the initial segment of the decoded streaming audio data. Additionally, while outputting the first portion of the initial segment, the systems refrain from outputting a leftover portion of the initial segment which is located temporally subsequent to the first portion of the initial segment.

It should be appreciated that there a many different ways in which the number of words to wait prior to outputting the punctuated segment is determined. For example, in some instances, the systems determine a number of newly decoded words to wait based on a context of the streaming audio. In some instances, the systems determine a number of newly decoded words to wait based on a type of audio device (e.g., a personal audio device or a multi-speaker audio device.) For example, if the type of audio device is a personal audio device, the system may employ a fewer number of “look-ahead” words because only one speaker is speaking. In contrast, if the device is a multi-speaker audio device which receives audio data from multiple speakers, the system may wait until a larger number of subsequent words are decoded in order to improve the accuracy of the segmentation/punctuation based on the more complicated/complex audio data being received.

In some instances, the systems determine a number of newly decoded words to wait based on a context of output application associated with the streaming audio data, such as a closed captioning of streaming audio data or a final transcript to be read after the audio stream is finished. For example, in live captioning of streaming audio data, speed of transcription display may be the most important parameter by which to optimize. In such cases, the system determines a lower number of look-ahead words in order to output speech transcriptions faster, while still having some validation of the punctuation. Alternatively, for a final transcript, accurate punctuation may be the most important parameter by which to optimize the audio processing, wherein a larger number of words are decoded and analyzed in order to validate the punctuation prior to being output as part of the final transcript.

Additionally, in some instances, the systems determine the number of newly decoded words to wait based on a speaking style associated with the speaker. For example, if the speaker is known to have or is detected to have a slower speaking rate with more pauses, even in the middle of sentences, the system will wait a longer number of words in order to validate the initial punctuation to prevent over-segmentation or time-out issues.

In some instances, the systems determine the number of newly decoded words to wait based on a pre-determined accuracy of the computing system used in applying the initial punctuation. For example, if the accuracy of the initial punctuation is known to be high, then the system can wait few words in order to validate the initial punctuation. However, if the accuracy of the initial punctuation is known to be low, the system may wait a larger number of words to ensure that the output punctuation is accurate. If initial accuracy is detected to be improving, the system can dynamically change/reduce the number of look-ahead words.

In some instances, the number of pre-determine words is based on which language is associated with the audio data. Some languages are easier to predict punctuation based on their language/grammatical rules and flow of speech than others.

Attention will now be directed to FIG. 8B which illustrates various examples of how punctuation is evaluated and validated prior to being transmitted to a user display. For example, input audio 822 comprises the punctuated transcription: “I am going to walk the dog tonight.” followed by a set of subsequently decoded words “im not going tomorrow”. The system identifies the punctuation 824 (e.g., period) which is associated with a potential linguistic boundary, just after the detected word “tonight” and before the detected word “im” (e.g., look-ahead word 826). In a configuration where the pre-determined number of words is one, the system looks ahead to the word “im” and generates a punctuation score based on how likely the punctuation after “tonight” is an accurate end-of-sentence punctuation. In this example, “im” is not a typical start to a new clause, but rather the start of a new speech utterance. Thus, the language segmentation model would calculate a high punctuation score. If that punctuation score meets or exceeds the punctuation score threshold, the system will transmit the complete sentence including the punctuation to the user display.

In another example, segment 828 comprises “I told you I walked the dog tonight at ten pm”. The system identifies a punctuation 830 after the word “dog” and will look ahead to one look-ahead word 832 comprising “tonight”. The system then analyzes the phrase “I told you I walked the dog tonight” and determines how likely the punctuation after “dog” is an end-of-sentence punctuation. In this example, the system returns a low punctuation score and refrains from outputting the segment 828 to the user display.

However, when the system analyzes more than one look-ahead word, the system returns a different, higher punctuation score. For segment 833, the system is configured to look-ahead at least six words (e.g., look-ahead words 838). A punctuation 836 is identified after “dog” and the system considers the whole input speech “I told you I walked the dog tonight at ten pm I will”. Because the phrase “tonight at ten pm I will” is likely the beginning of a new sentence, the system calculates a high punctuation score for the potential segmentation boundary 432. If the language segmentation score meets or exceeds a punctuation score threshold, the system will output the complete sentence “I told you I walked the dog.” included in the segment 833 to the user display.

Thus, systems that segment audio based on a tunable number of look-ahead words, as shown in FIG. 8A-8B, provide technical advantages over conventional systems, including the ability to incorporate smart technology into punctuating phrases and evaluating punctuation for continuous speech. The disclosed embodiments provide a way to produce semantically meaningful segments and correct punctuation which improves the machine transcription and/or translation quality. With this innovation where the punctuation engine “looks ahead” past an initial end-of-sentence punctuation, the systems can detect the utterance of a clause and prevent early segmentation.

This leads to better readability of the text after the speech utterances are transcribed. Improvement of segmentation and punctuation with these technologies will beneficially improve operations in video conference calling with real-time transcriptions as well as other types of speech-to-text applications. Better segmented speech also improves quality of speech recognition in order to understand meaning and also for using speech as a natural user interface. Overall, disclosed systems improve the efficiency and quality of transmitting linguistically and acoustically meaning, especially in streaming mode when displayed at a user display.

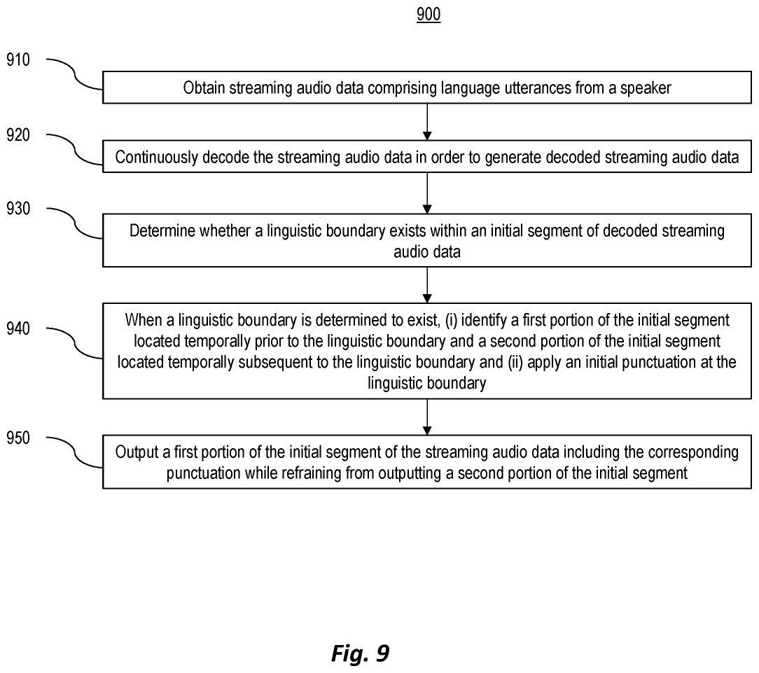

Attention will now be directed to FIG. 9 which illustrates a flow diagram 900 that includes various acts (act 910, act 920, act 930, act 940, and act 950) associated with exemplary methods that can be implemented by computing system 210 for generating speech transcriptions. For example, FIG. 9 illustrates a method for generating improved speech transcriptions by refraining from outputting incomplete speech transcriptions to the user display.

The first illustrated act includes an act of obtaining streaming audio data comprising language utterances from a speaker (act 910). The computing system continuously decodes the streaming audio data in order to generate decoded streaming audio data (act 920) and determines whether a linguistic boundary exists within an initial segment of decoded streaming audio data (act 930). When a linguistic boundary is determined to exist, the system (i) identifies a first portion of the initial segment located temporally prior to the linguistic boundary and a second portion of the initial segment located temporally subsequent to the linguistic boundary and (ii) applies a punctuation at the linguistic boundary (act 940). The system outputs a first portion of the initial segment of the streaming audio data ending at the linguistic boundary while refraining from outputting a second portion of the initial segment (act 950). Alternatively, when a when a linguistic boundary is determined not to exist within the initial segment of decoded streaming audio data, the system refrains from outputting the initial segment of decoded streaming audio data.

By implementing segmentation output in this manner, the disclosed embodiments experience a decreased degradation in latency, thus enabling live captions scenario. The live captions scenario is improved both from improved segmentation and improved punctuation provided by the systems herein. The disclosed embodiments also provide for improved readability of speech transcriptions by users at the user display/user interface. There is also a significant reduction in mid-sentence breaks, which also improves user readability. Notably, these benefits are realized without a degradation in the word error rate, while sentences are rendered with significantly lower delay.

Output from such systems can also be used as training data, which can significantly improve overall training process. For example, the application of training data with improved segmentation and punctuation will correspondingly improve the training processes using such data by requiring less training data, during training, in order to achieve the same level of system accuracy that would be required with using higher volumes of less accurate training data. Additionally, the time required to train the automatic speech recognition system can also be reduced when using more accurate training data. In at least this regard, the quality of the training can be improved with the use of training data generated by the disclosed systems and by using the techniques described herein, by enabling systems to generate segmented and punctuated data better than conventional systems that are trained on sentences which are not as accurately punctuated. The trained systems utilizing the disclosed techniques can also perform runtime NLP processes more accurately and efficiently than conventional systems, by at least reducing the amount of error correction that is needed.

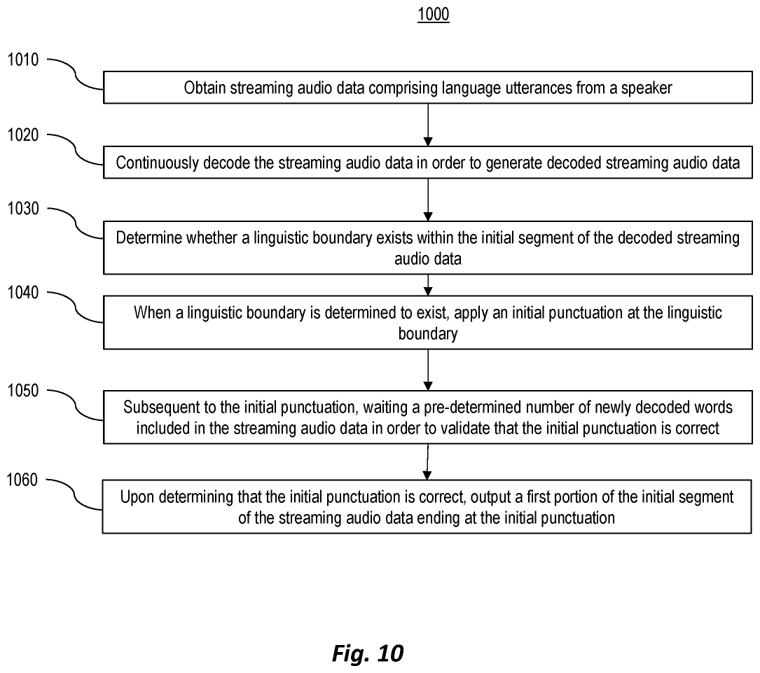

Attention will now be directed to FIG. 10 which illustrates a flow diagram 1000 that includes various acts (act 1010, act 1020, act 1030, act 1040, act 1050, and act 1060) associated with exemplary methods that can be implemented by computing system 110 for segmenting and punctuating audio to generate improved speech transcriptions. For example, FIG. 10 illustrates one embodiment of a flow diagram having a plurality of acts for generating improved speech transcriptions based on delaying the output of punctuated speech segments until the punctuation has been validated by waiting a pre-determined number of newly decoded words.

The first illustrated act includes an act of obtaining streaming audio data comprising language utterances from a speaker (act 1010). The computing system continuously decodes the streaming audio data in order to generate decoded streaming audio data (act 1020) and determine whether a linguistic boundary exists within an initial segment of decoded streaming audio data (act 1030). When a linguistic boundary is determined to exist, the system applies an initial punctuation at the linguistic boundary (act 1040). Notably, subsequent to the initial punctuation, the system waits a pre-determined number of newly decoded words included in the streaming audio data in order to validate that the initial punctuation is correct (act 1050). Upon determining that the initial punctuation is correct, the system outputs a first portion of the initial segment of the streaming audio data ending at the initial punctuation (act 1060).

The systems are further configured to transmit the first portion of the initial segment of the streaming audio data to a user display and display the first portion of the initial segment including the initial punctuation. This first portion of the initial segment can then be presented on a user display with a higher system and user confidence that it is a correctly segmented and punctuated transcription of the audio data.

### Example Computing Systems

Embodiments of the present invention may comprise or utilize a special purpose or general-purpose computer (e.g., computing system 210) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media (e.g., hardware storage device(s) 240 of FIG. 2) that store computer-executable instructions (e.g., computer-executable instructions 218 of FIG. 2) are physical hardware storage media/devices that exclude transmission media. Computer-readable media that carry computer-executable instructions or computer-readable instructions (e.g., computer-executable instructions 218) in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 230 of FIG. 2) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computing system for generating transcriptions of language utterances occurring in streaming audio data, the computing system comprising:
a processor; and
a hardware storage device storing computer-executable instructions that are executable by the processor to cause the computing system to:
obtain streaming audio data comprising language utterances from a speaker;
continuously decode the streaming audio data in order to generate decoded streaming audio data;
determine whether a linguistic boundary exists within an initial segment of decoded streaming audio data;
when a linguistic boundary is determined to exist, (i) identify a first portion of the initial segment located temporally prior to the linguistic boundary and a second portion of the initial segment located temporally subsequent to the linguistic boundary and (ii) apply a punctuation corresponding to the first portion of the initial segment at the linguistic boundary; and
output the first portion of the initial segment of the streaming audio data including the corresponding punctuation, while refraining from outputting the second portion of the initial segment.

2. The computing system of claim 1, the computer-executable instructions further executable by the processor to cause the computing system to:
store the initial segment of decoded streaming audio data in a cache; and
after outputting the first portion of the initial segment, clear the cache of the first portion of the initial segment of the decoded streaming audio data.

3. The computing system of claim 2, the computer-executable instructions further executable by the processor to cause the computing system to:
while clearing the cache of the first portion of the initial segment of decoded streaming audio data, retain the second portion of the segment of decoded streaming audio data in the cache.

4. The computing system of claim 3, the computer-executable instructions further executable by the processor to cause the computing system to:
store a subsequent segment of decoded streaming audio data in the cache, wherein the subsequent segment of decoded streaming audio data is appended to the second portion of the initial segment of decoded streaming audio data to form a new segment of decoded streaming audio data;
determine whether a subsequent linguistic boundary exists within the new segment of decoded streaming audio data;
when a subsequent linguistic boundary is determined to exist, apply a new punctuation at the subsequent linguistic boundary; and
output a first portion of the new segment of the streaming audio data ending at the subsequent linguistic boundary while refraining from outputting a second portion of the new segment located temporally subsequent to the second portion of the initial segment.

5. The computing system of claim 1, the computer-executable instructions further executable by the processor to cause the computing system to:
apply the punctuation prior to outputting the first portion of the initial segment of decoded streaming audio data.

6. The computing system of claim 1, the computer-executable instructions further executable by the processor to cause the computing system to:
apply the punctuation while outputting the first portion of the initial segment of decoded streaming audio data.

7. The computing system of claim 1, the computer-executable instructions further executable by the processor to cause the computing system to:
apply the punctuation after outputting the first portion of the initial segment of decoded streaming audio data.

8. The computing system of claim 1, the computer-executable instructions further executable by the processor to cause the computing system to:
when a linguistic boundary is determined not to exist within the initial segment of decoded streaming audio data, refrain from outputting the initial segment of decoded streaming audio data.

9. The computing system of claim 1, the computer-executable instructions further executable by the processor to cause the computing system to:
determine whether the linguistic boundary exists based on a user command or a detected keyword recognized within the initial segment of decoded streaming audio data.

10. The computing system of claim 1, the computer-executable instructions further executable by the processor to cause the computing system to:
after applying the punctuation and outputting the first portion of the initial segment of decoded streaming audio data, displaying the first portion of the initial segment of decoded streaming audio data at a user display.

11. The computing system of claim 1, the computer-executable instructions further executable by the processor to cause the computing system to:
recognize a sentiment associated the first portion of the initial segment of decoded streaming audio data; and
apply a visual formatting corresponding to the sentiment associated with the first portion of the initial segment of decoded streaming audio data to the first portion of the initial segment of decoded streaming audio data, wherein a different visual formatting is applied to a different sentiment detected for a different portion of decoded streaming audio data.

12. The computing system of claim 1, the computer-executable instructions further executable by the processor to cause the computing system to:
identify a speaker role attributed to a speaker of the first portion of the initial segment of decoded streaming audio data; and
apply a visual formatting corresponding to the speaker role attributed to the speaker of the first portion of the initial segment of decoded streaming audio data, wherein a different visual formatting is applied to decoded streaming audio data attributed to a different speaker role.

13. The computing system of claim 1, the computer-executable instructions further executable by the processor to cause the computing system to:
identify an action item within the first portion of the initial segment of decoded streaming audio data; and
apply a visual formatting corresponding to the action item associated with the first portion of the initial segment of decoded streaming audio data to the first portion of the initial segment of decoded streaming audio data, wherein different visual formatting is applied to decoded streaming audio data associated with a different action item at a user display.

14. The computing system of claim 1, the computer-executable instructions further executable by the processor to cause the computing system to:
identify external content associated with the first portion of the initial segment of decoded streaming audio data;
embed a link within the first portion of the initial segment of decoded streaming audio data to the first portion of the initial segment of decoded streaming audio data, wherein the link directs a user to the external content; and
display the link as a selectable object at a user display.

15. The computing system of claim 1, the computer-executable instructions further executable by the processor to cause the computing system to:
obtain streaming audio data comprising language utterances from multiple speakers and multiple audio input devices, wherein the streaming audio data is separated into a plurality of audio data streams according to each audio input device such that each audio data stream and each audio stream is analyzed by a different orchestrator.

16. The computing system of claim 1, the computer-executable instructions further executable by the processor to cause the computing system to:
obtain multiple outputs and combine the multiple outputs into a paragraph prior to transmitting the paragraph to an output for display.

17. The computing system of claim 1, the computer-executable instructions further executable by the processor to cause the computing system to:
obtain multiple outputs from different speakers; and
combine outputs according to each of the different speakers.

18. A method implemented by a computing system for generating throttled closed captions of streaming audio data, the method comprising:
obtaining streaming audio data comprising language utterances from a speaker;
continuously decoding the streaming audio data in order to generate decoded streaming audio data;
determining whether a linguistic boundary exists within an initial segment of decoded streaming audio data;
when a linguistic boundary is determined to exist, applying a punctuation at the linguistic boundary; and
outputting a first portion of the initial segment of the streaming audio data ending at the linguistic boundary while refraining from outputting a second portion of the initial segment which is located temporally subsequent to the first portion of the initial segment.

19. A computing system for generating transcriptions of language utterances occurring in streaming audio data, the computing system comprising:
a processor; and
a hardware storage device storing computer-executable instructions that are executable by the processor to cause the computing system to:
obtain streaming audio data comprising language utterances from a speaker;
continuously decode the streaming audio data in order to generate decoded streaming audio data;
determine whether a linguistic boundary exists within an initial segment of decoded streaming audio data;
when a linguistic boundary is determined to exist, apply an initial punctuation at the linguistic boundary;
subsequent to the initial punctuation, wait a pre-determined number of newly decoded words included in the streaming audio data in order to validate that the initial punctuation is correct; and
upon determining that the initial punctuation is correct, output a first portion of the initial segment of the streaming audio data ending at the initial punctuation.

20. The computing system of claim 19, the computer-executable instructions being further executable by the processor to cause the computing system to:
transmit the first portion of the initial segment of the streaming audio data to a user display; and
display the first portion of the initial segment including the initial punctuation.

21. The computing system of claim 19, the computer-executable instructions being further executable by the processor to cause the computing system to:
upon determining that the initial punctuation is not correct, remove the initial punctuation from the initial segment of decoded streaming audio data; and
refrain from outputting the initial segment of decoded streaming audio data.

22. The computing system of claim 19, the computer-executable instructions being further executable by the processor to cause the computing system to:
while outputting the first portion of the initial segment, refraining from outputting a leftover portion of the initial segment which is located temporally subsequent to the first portion of the initial segment.

23. The computing system of claim 19, the computer-executable instructions being further executable by the processor to cause the computing system to:
determine a number of newly decoded words to wait based on a context of the streaming audio data.

24. The computing system of claim 19, the computer-executable instructions being further executable by the processor to cause the computing system to:
determine a number of newly decoded words to wait based on a type of audio device.

25. The computing system of claim 24, wherein the type of audio device is identified as at least one of a following: a personal audio device or a multi-speaker audio device.

26. The computing system of claim 19, the computer-executable instructions being further executable by the processor to cause the computing system to:
determine a number of newly decoded words to wait based on a context of output application associated with the streaming audio data.

27. The computing system of claim 26, wherein the context of output application is identified as at least one of a following: a closed captioning of streaming audio data or a final transcript.

28. The computing system of claim 19, the computer-executable instructions being further executable by the processor to cause the computing system to:
determine a number of newly decoded words to wait based on a speaking style associated with the speaker.

29. The computing system of claim 19, the computer-executable instructions being further executable by the processor to cause the computing system to:
determine a number of newly decoded words to wait based on a pre-determined accuracy of the computing system in applying the initial punctuation.

30. The computing system of claim 19, wherein the hardware storage device also stores a machine learning model configured as an automatic speech recognition system comprising:
a decoder configured to decode spoken language utterances and generate a transcription of the spoken language utterances;
a punctuator configured to punctuate the transcription based on an identified linguistic boundary within the transcription of the spoken language utterances; and
an intermediary orchestrator configured to hold a portion of the transcription until the initial punctuation is validated.

31. The computing system of claim 19, wherein the audio data is a pre-recorded set of audio data.

32. A method for generating transcriptions of audio data, the method comprising:
obtaining streaming audio data comprising language utterances from a speaker;
continuously decoding the streaming audio data in order to generate decoded streaming audio data;
determining whether a linguistic boundary exists within an initial segment of decoded streaming audio data;
when a linguistic boundary is determined to exist, applying an initial punctuation at the linguistic boundary;
subsequent to the initial punctuation, waiting a pre-determined number of newly decoded words included in the streaming audio data in order to validate that the initial punctuation is correct; and
upon determining that the initial punctuation is correct, outputting a first portion of the initial segment of the streaming audio data ending at the initial punctuation.

33. The method of claim 32 further comprising:
transmitting the first portion of the initial segment of the streaming audio data to a user display; and
displaying the first portion of the initial segment including the initial punctuation.
